(19) United States
(12) Patent Application Publication
(10) Pub. No.: US 2011/0176085 A1
(43) Pub. Date: Jul. 21, 2011

(54) BACKLIGHT UNIT AND DISPLAY DEVICE HAVING THE SAME

(75) Inventor: Dong Wook PARK, Seoul (KR)

(73) Assignee: LG Innotek Co., Ltd.

(21) Appl. No.: 13/006,961

(22) Filed: Jan. 14, 2011

(30) Foreign Application Priority Data
Jan. 15, 2010 (KR) 10-2010-0004117

(51) Int. Cl. G02F 1/1335; F21V 7/22

(52) U.S. Cl. 349/62; 362/606; 362/607

(57) ABSTRACT

A backlight unit may include a light emitting part to emit light, an optical engine in which light provided from the light emitting part propagates, and a light guide plate in which light provided from the optical engine propagates. Light dispersion members may be provided on a surface of the optical engine from which light is emitted to the light guide plate.

### CROSS-REFERENCE TO RELATED APPLICATION

The present application claims priority from Korean Patent Application No. 10-2010-0004117, filed Jan. 15, 2010, the subject matter of which is incorporated herein by reference.

### BACKGROUND

1. Field

The present disclosure relates to a backlight unit and a display device that includes the backlight unit.

2. Background

A liquid crystal display may include a liquid crystal panel configured to display images, and a backlight unit disposed under the liquid crystal panel to provide light to the liquid crystal panel. The backlight unit may include a lamp or a light emitting diode (LED) as a light source.

Display devices, such as liquid crystal displays, may be required to be much slimmer to satisfy customer's demands. Additionally, manufacturing cost reduction and efficient use of light may be required.

### BRIEF DESCRIPTION OF THE DRAWINGS

Arrangements and/or embodiments may be described in detail with reference to the following drawings in which like reference numerals refer to like elements and wherein:

FIG. 1 is a perspective view illustrating a backlight unit according to an embodiment;

FIG. 2 is a sectional view taken along line A-A of FIG. 1;

FIG. 3 is a view illustrating an optical engine shown in FIG. 1;

FIG. 4 is a view illustrating a backlight unit according to an embodiment;

FIG. 5 is a view illustrating a backlight unit according to an embodiment;

FIG. 6 is a view illustrating a liquid crystal display according to an embodiment;

FIG. 7 is a perspective view illustrating a backlight unit according to another embodiment;

FIG. 8 is a sectional view taken along line B-B of FIG. 7;

FIG. 9 is a view illustrating a light guide plate shown in FIG. 7;

FIG. 10 is a view illustrating a backlight unit according to an embodiment; and

FIG. 11 is a view illustrating a backlight unit according to an embodiment.

### DETAILED DESCRIPTION

In the following description, it may be understood that when a part such as a layer (film), a region, a pattern, a structure, and a substrate is referred to as being ‘on’ another part, it may be directly on the another part, or intervening parts may also be present. Further, it may be understood that when a part is referred to as being ‘under’ another part, it may be directly under the other part, and one or more intervening parts may also be present. Additionally, it may also be understood that when a part is referred to as being ‘between’ two parts, it may be the only part between the two parts, or one or more intervening parts may also be present. Spatially relative terms, such as “upper” and “lower” may be used herein for ease of description to describe one element or feature's relationship to another element(s) or feature(s) as shown in the figures.

In the drawings, thicknesses or sizes of layers may be exaggerated, omitted, and/or schematically shown for brevity of description and clarity. Additionally, sizes of elements shown in the drawings may be different from their real sizes.

Embodiments may now be described with reference to the accompanying drawings.

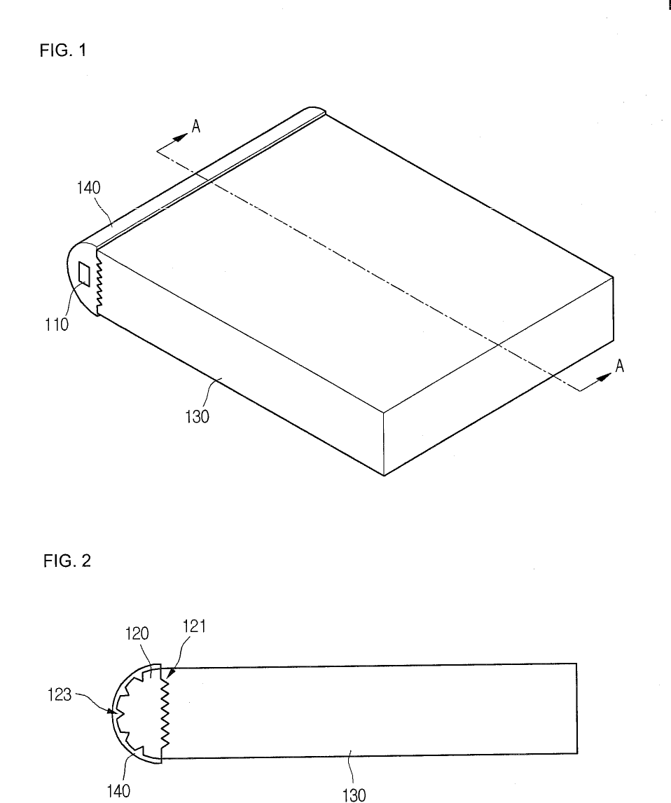

FIG. 1 is a perspective view illustrating a backlight unit according to an embodiment. FIG. 2 is a sectional view taken along line A-A of FIG. 1, and FIG. 3 is a view illustrating an optical engine shown in FIG. 1. Other embodiments and configurations may also be provided.

A backlight unit may include a light emitting part 110, an optical engine 120, a light guide plate 130, and a reflector 140.

The light emitting part 110 may include a light emitting device such as a light emitting diode. Alternatively, the light emitting part 110 may include a light emitting device package. The light emitting part 110 may include a red light emitting device, a green light emitting device, a blue light emitting device, and/or a white light emitting device. The light emitting part 110 may provide light to the optical engine 120.

The light emitting part 110 may be provided (or disposed) at a side or sides of the optical engine 120. For example, the light emitting part 110 may be provided (or disposed) at a side (or end) of the optical engine 120. The light emitting part 110 may also be provided (or disposed) at both sides (or both ends) of the optical engine 120. The reflector 140 may be provided (or disposed) at the optical engine 120. The reflector 140 may be provided (or disposed) at rear and lateral sides of the optical engine 120. Light emitted from the light emitting part 110 may propagate through an inside of the optical engine 120. Light emitted from the light emitting part 110 provided at a side (or end) of the optical engine 120 may propagate to another side (or another end) of the optical engine 120. Light emitted from the light emitting part 110 may be reflected by the reflector 140 toward another side (or another end) of the optical engine 120.

FIG. 3 shows first light dispersion members 121 provided (or disposed) on a surface (or at a surface) of the optical engine 120. The first light dispersion members 121 may also be called first uneven parts. Uneven parts corresponding to the first light dispersion members 121 may be provided on a surface of the light guide plate 130 facing the surface of the optical engine 120 where the first light dispersion members 121 are provided. That is, the first light dispersion members 121 may be provided on the surface of the optical engine 120 from which light is emitted to the light guide plate 130. The first light dispersion members 121 may disperse the light from the optical engine 120.

Based on the first light dispersion members 121, light propagating in the optical engine 120 may be efficiently extracted to outside of the optical engine 120. The light extracted from the optical engine 120 to the outside may be efficiently incident on the light guide plate 130. Light provided by the optical engine 120 may propagate in the light guide plate 130, and may be extracted out through an upper side of the light guide plate 130. In at least one embodiment, the first light dispersion members 121 may be considered as part of the optical engine 120.

FIG. 3 shows that second light dispersion members 123 may be provided (or disposed) on a surface of the optical engine 120 that corresponds to the reflector 140. The second light dispersion members 123 may also be called second uneven parts. The second light dispersion members 123 may be formed along a first direction that is parallel to a longitudinal axis (or length direction) of the optical engine 120. Based on the second light dispersion members 123, light emitted from the light emitting part 110 may be efficiently dispersed within the optical engine 120. The reflector 140 may be provided at a backside of the second light dispersion members 123. Thus, light incident on the second light dispersion members 123 may be reflected and efficiently dispersed within the optical engine 120. In at least one embodiment, the second light dispersion members 123 may be considered as part of the optical engine 120.

The reflector 140 may be formed of a metal such as silver (Ag), tungsten (W), and aluminum (Al), and/or another reflective material. The optical engine 120 may be formed of a resin. The reflector 140 may be provided on the optical engine 120 by deposition or coating. For example, the optical engine 120 may be formed of a material such as polyimide (Pl) or polymethylmethacrylate (PMMA). Alternatively, the optical engine 120 may be formed of a silicon resin or an epoxy resin.

Still further, FIG. 3 shows that third light dispersion members 125 may be provided on the optical engine 120. The third light dispersion members 125 may also be called third uneven parts. The third light dispersion members 125 may be formed along a second direction that is perpendicular to the longitudinal axis (or length direction) of the optical engine 120. Based on the second light dispersion members 123 and the third light dispersion members 125, light emitted from the light emitting part 110 may be reflected and dispersed. Light emitted from the light emitting part 110 that is provided at a side (or end) of the optical engine 120 may propagate to another side (or another end) of the optical engine 120. Light reflected by the second light dispersion members 123 and the third light dispersion members 125 may be incident on the light guide plate 130. In at least one embodiment, the third light dispersion member may be considered as part of the optical engine 120.

Light emitted from the light emitting part 110 provided at a side (or end) of the optical engine 120 may propagate uniformly through an inside of the optical engine 120. The light uniformly propagating in the optical engine 120 may be uniformly supplied to the light guide plate 130. That is, although the light emitting part 110 is provided at a side (or end) of the optical engine 120, light may be sufficiently supplied to the light guide plate 130. Therefore, fewer light emitting devices may be used in the backlight unit, and thus the backlight unit may be manufactured through simple processes with lower costs.

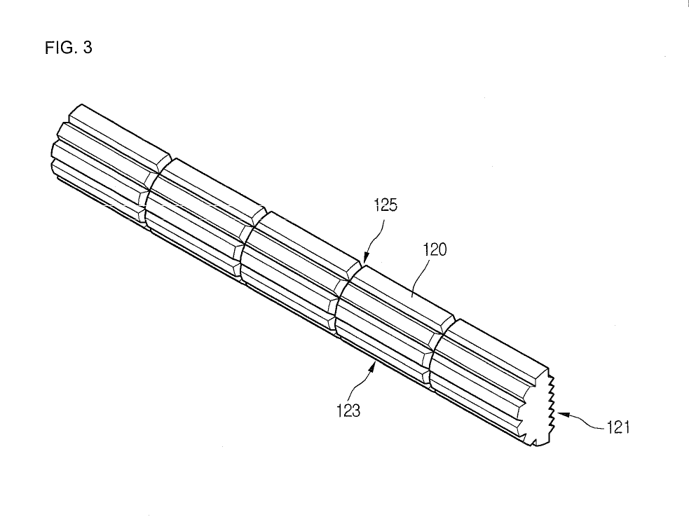

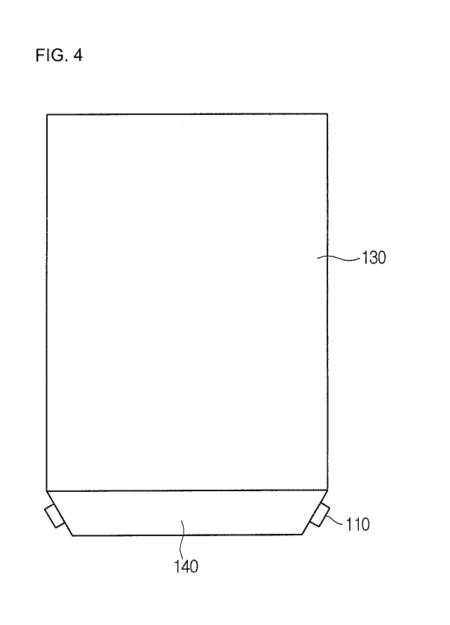

As shown in FIG. 4, the side (or longitudinal end) of the optical engine 120, where the light emitting part 110 is provided, may be inclined. The longitudinal ends of the optical engine 120 may be inclined. Thus, an incident angle of light emitted from the light emitting part 110 may be adjusted. The side (or end) of the optical engine 120 may be inclined such that some of light emitted from the light emitting part 110 may be toward the light guide plate 130. FIG. 4 does not show the optical engine 120 since it is behind the reflector 140.

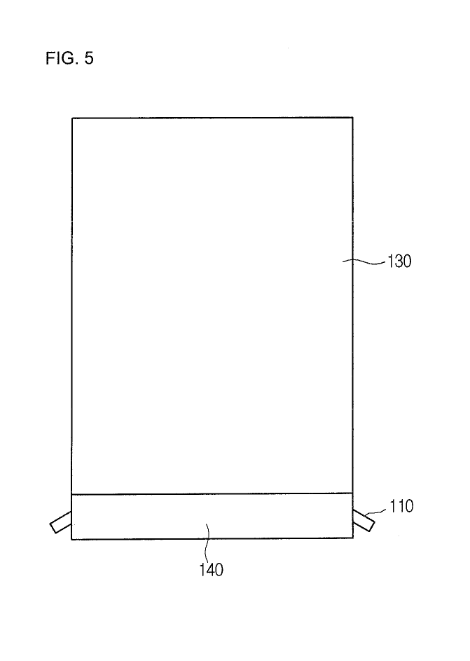

As shown in FIG. 5, the light emitting part 110 may be provided at a side (or longitudinal end) of the optical engine 120 in an inclined position. For example, rather than inclining a side of the optical engine 120, the light emitting part 110 may be provided in an inclined position. The incident angle of light emitted from the light emitting part 110 may be adjusted. The angle of the light emitting part 110 may be adjusted so that some of light emitted from the light emitting part 110 may be toward the light guide plate 130. FIG. 5 does not show the optical engine 120 since it is behind the reflector 140.

The first to third light dispersion members 121, 123 and 125 may each have a groove shape. The groove shape may vary. The first to third light dispersion members 121, 123, and 125 may have a protrusion shape. The first to third light dispersion members 121, 123, and 125 may have a regular pattern shape and/or a random pattern shape. According to characteristics of an optical system, shapes of the first to third light dispersion members 121, 123, and 125 may vary for optimization.

The light emitting part 110 may be provided at a side (or end) of the optical engine 120. For example, the light emitting part 110 may be provided in contact with a side (or end) of an outside of the optical engine 120. In another example, the light emitting part 110 may be provided at a side (or longitudinal end) of an inside of the optical engine 120.

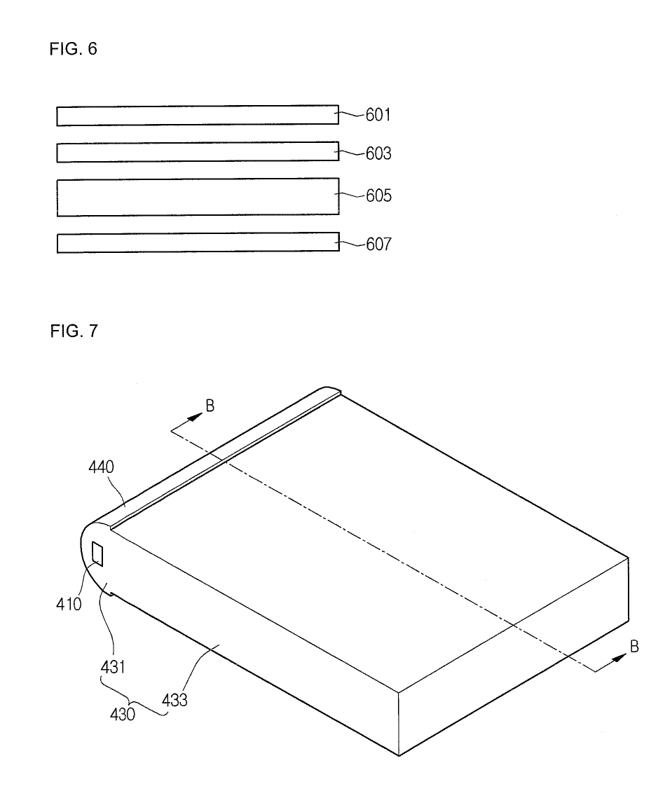

The above-described backlight unit may be applied to a display device such as a liquid crystal display. As shown in FIG. 6, a backlight unit 605 may be provided under a liquid crystal panel 601 to constitute a display device. The liquid crystal panel 601 may display images by using light emitted from the backlight unit 605. An optical sheet 603 may be provided between the backlight unit 605 and the liquid crystal panel 601. The optical sheet 603 may include one or more sheets. The optical sheet 603 may include a diffusion sheet and a prism sheet. A reflection plate 607 may be provided under the backlight unit 605. The reflection plate 607 may be provided under the backlight unit 605 so that light emitted from the backlight unit 605 may be reflected upward.

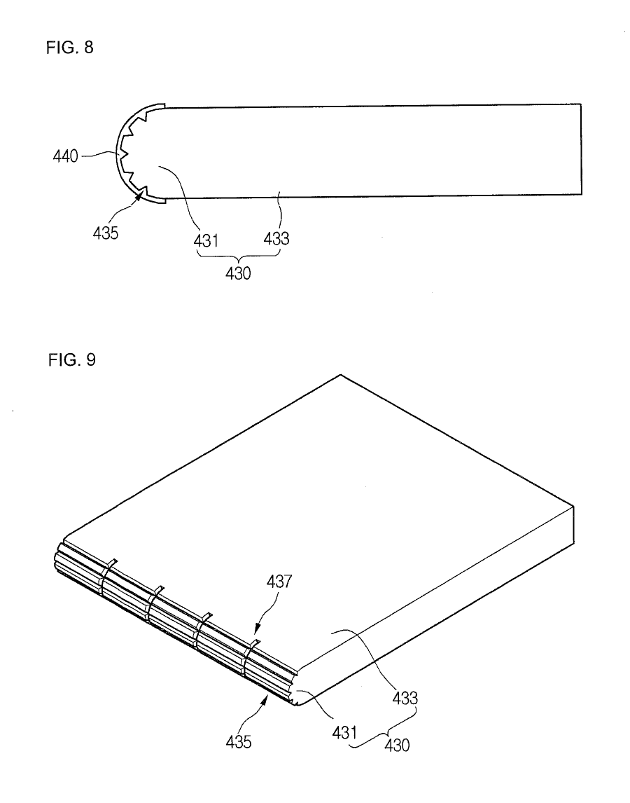

FIG. 7 is a perspective view illustrating a backlight unit according to an embodiment. FIG. 8 is a sectional view taken along line B-B of FIG. 7, and FIG. 9 is a view illustrating a light guide plate shown in FIG. 7. Other embodiments and configurations may also be provided.

The backlight unit may include a light emitting part 410, a light guide plate 430, and a reflector 440.

The light emitting part 410 may include a light emitting device such as a light emitting diode. The light emitting part 410 may include a red light emitting device, a green light emitting device, a blue light emitting device, and/or a white light emitting device. The light emitting part 410 may provide light to the light guide plate 430.

The light guide plate 430 may include an optical engine 431 and an optical propagation part 433. Light provided from the light emitting part 410 may propagate through the optical engine 431. Light provided from the optical engine 431 may propagate through the optical propagation part 433. The optical engine 431 and the optical propagation part 433 may be provided in one piece (and/or as an integral component). That is, the optical engine 431 and the optical propagation part 433 may be integrated and may be provided as one body.

The light emitting part 410 may be provided at a side (or end) or sides (or ends) of the optical engine 431. For example, the light emitting part 410 may be provided at a side (or longitudinal end) of the optical engine 431. In another example, the light emitting part 410 may be provided at both sides (or both ends) of the optical engine 431. The reflector 440 may be provided at the optical engine 431. The reflector 440 may be provided at rear and lateral sides of the optical engine 431. Light emitted from the light emitting part 410 may propagate through an inside of the optical engine 431. Light emitted from the light emitting part 410 provided at a side (or end) of the optical engine 431 may propagate to another side (or another end) of the optical engine 431. Additionally, light emitted from the light emitting part 410 may be reflected by the reflector 440 toward another side of the optical engine 431. Light provided from the optical engine 431 may propagate through an inside of the optical propagation part 433 from the optical propagation part 433. Light propagating in the optical propagation part 433 may be extracted upward.

FIGS. 8-9 show first light dispersion members 435 provided at a surface of the optical engine 431 corresponding to the reflector 440. Based on the first light dispersion member 435, light provided from the light emitting part 410 may propagate and disperse efficiently in the optical engine 431. The reflector 440 may be provided at a backside of the first light dispersion members 435. Thus, light incident on the first light dispersion members 435 may be reflected and dispersed efficiently in the optical engine 431.

The reflector 440 may be formed of a metal such as silver (Ag), tungsten (W), and aluminum (Al), and/or another reflective material. The optical engine 431 may be formed of a resin. The reflector 440 may be provided on the optical engine 431 by deposition or coating. For example, the optical engine 431 may be formed of a material such as polyimide (Pl) or polymethylmethacrylate (PMMA).

FIG. 9 shows that second light dispersion members 437 may be provided at the optical engine 431. Based on the first light dispersion members 435 and the second light dispersion members 437, light provided from the light emitting part 410 may be reflected and dispersed. Thus, light emitted from the light emitting part 410 provided at a side (or longitudinal end) of the optical engine 431 may propagate to another side (or another end) of the optical engine 431. Additionally, light reflected by the first light dispersion members 435 and the second light dispersion members 437 may be efficiently incident on the light guide plate 430.

Light emitted from the light emitting part 410 provided at a side (or end) of the optical engine 431 may propagate uniformly through an inside of the optical engine 431. Additionally, the light uniformly propagating in the optical engine 431 may be uniformly supplied to the light guide plate 430. That is, although the light emitting part 410 is provided at a side (or end) of the optical engine 431, light may be sufficiently supplied to the light guide plate 430. Therefore, fewer light emitting devices may be used in the backlight unit, and thus the backlight unit may be manufactured through simple processes with lower costs.

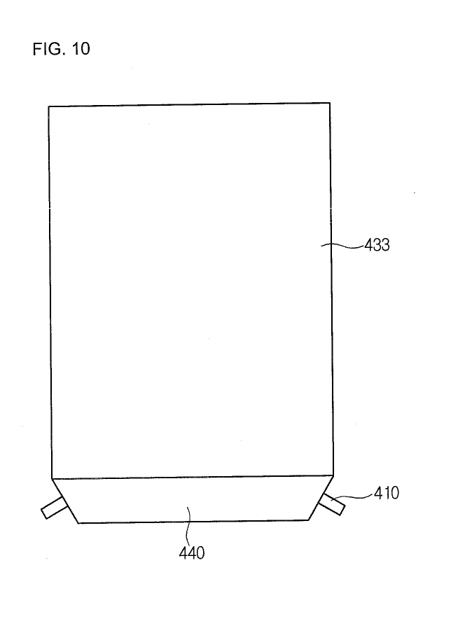

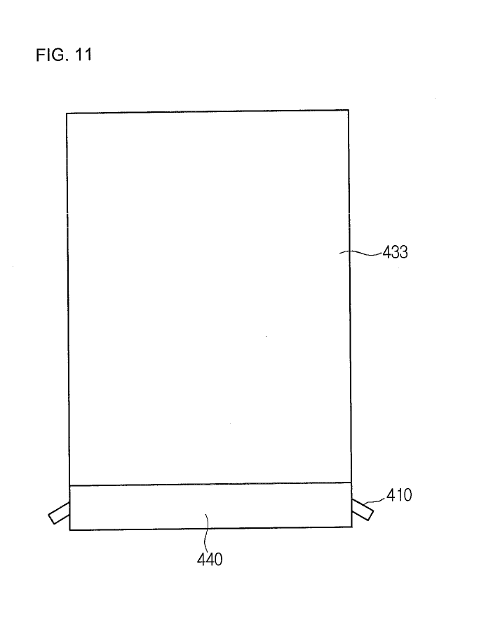

As shown in FIG. 10, the side (or end) of the optical engine 431, where the light emitting part 410 is provided may be inclined. Thus, an incident angle of light emitted from the light emitting part 410 may be adjusted. The side of the optical engine 431 may be inclined such that some of light emitted from the light emitting part 410 can be toward the optical propagation part 433. FIG. 10 does not show the optical engine 431 since it is behind the reflector 440.

As shown in FIG. 11, the light emitting part 410 may be provided at a side (or longitudinal end) of the optical engine 431 in an inclined position. For example, rather than inclining a side of the optical engine 431, the light emitting part 410 may be provided in an inclined position. The incident angle of light emitted from the light emitting part 410 may be adjusted. The angle of the light emitting part 410 may be adjusted so that some of light emitted from the light emitting part 410 may be toward the optical propagation part 433. FIG. 11 does not show the optical engine 431 since it is behind the reflector 440.

The first and second light dispersion members 435 and 437 may each have a groove shape. The groove shape may vary. The first and second light dispersion members 435 and 437 may have a protrusion shape. The first and second light dispersion members 435 and 437 may have a regular pattern shape and/or a random pattern shape. According to characteristics of an optical system, shapes of the first and second light dispersion members 435 and 437 may vary for optimization.

The light emitting part 410 may be provided at a side (or end) of the optical engine 431. For example, the light emitting part 410 may be provided in contact with a side (or longitudinal end) of an outside of the optical engine 431. In another example, the light emitting part 410 may be disposed at a side (or longitudinal end) of the inside of the optical engine 431.

The above-described backlight unit may be applied to a display device such as a liquid crystal display. That is, the backlight unit may be provided under a liquid crystal panel to constitute a display device. The liquid crystal panel may display images by using light emitted from the backlight unit. An optical sheet may be provided between the backlight unit and the liquid crystal panel. The optical sheet may include one or more sheets. The optical sheet may include a diffusion sheet and a prism sheet. A reflection plate may be provided under the backlight unit. The reflection plate may be provided under the backlight unit so that light emitted from the backlight unit may be reflected upward.

As described above, embodiments may provide a backlight unit that can provide light efficiently and may be made with lower costs. Embodiments may also provide a display device that includes the backlight unit.

Each of the dispersion members discussed above may also be a diffusing surface having a jagged surface. The jagged surface (or uneven parts) that include jagged protrusions may be a prism. The surface having the plurality of prisms may be called a prismatic surface to diffuse the light. This terminology and/or further description applies to each of the first light dispersion members 121, the second light dispersion members 123, the third light dispersion members 125, the first light dispersion members 435 and the second light dispersion members 437.

Embodiments may be applied to light emitting devices for providing light efficiently.

Embodiments may provide a backlight unit that can provide light efficiently and may be made with lower costs. Embodiments may also provide a display device that includes the backlight unit.

A backlight unit may include a light emitting part configured to emit light, an optical engine in which light provided from the light emitting part propagates, and a light guide plate in which light provided from the optical engine propagates. Light dispersion members (or uneven parts) may be provided a surface of the optical engine from which light is emitted.

A display device may include a backlight unit, and a liquid crystal panel configured to receive light from the backlight unit. The backlight unit may include a light emitting part configured to emit light, an optical engine in which light provided from the light emitting part propagates, and a light guide plate in which light provided from the optical engine propagates. Light dispersion members (or uneven parts) may be provided on a surface of the optical engine from which light is emitted.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a light emitting part to provide light;
an optical engine to propagate light received from the light emitting part, the optical engine including a first surface having first light dispersion members to disperse the light from the optical engine; and
a light guide plate to receive light from the first light dispersion members and to propagate the received light to outside of the light guide plate.

2. The backlight unit according to claim 1, wherein the light emitting part comprises a light emitting device.

3. The backlight unit according to claim 1, wherein the light emitting part is provided at a longitudinal end of the optical engine.

4. The backlight unit according to claim 3, wherein the longitudinal end of the optical engine is inclined.

5. The backlight unit according to claim 3, wherein the light emitting part is provided in an inclined manner at the longitudinal end of the optical engine.

6. The backlight unit according to claim 1, further comprising a reflector provided at a second surface of the optical engine to reflect the light within the optical engine.

7. The backlight unit according to claim 6, further comprising second light dispersion members provided at an area of the optical engine that corresponds to the reflector, the second light dispersion members to disperse the light within the optical engine.

8. The backlight unit according to claim 7, wherein the second light dispersion members are arranged in a first direction parallel to a longitudinal axis of the optical engine.

9. The backlight unit according to claim 7, further comprising third light dispersion members formed on the optical engine in a direction transverse to the first direction.

10. The backlight unit according to claim 1, wherein the first light dispersion members are groove shaped or protrusion shaped on the first surface of the optical engine.

11. The backlight unit according to claim 1, wherein the first light dispersion members are provided in a regular pattern shape or a random pattern shape on the first surface of the optical engine.

12. A display device comprising:
the backlight unit of claim 1; and
a liquid crystal panel to receive light from the backlight unit.

13. The display device according to claim 12, further comprising an optical sheet between the backlight unit and the liquid crystal panel.

14. The display device according to claim 12, further comprising a reflection plate under the backlight unit.

15. A backlight unit comprising:
an optical engine that extends along a longitudinal axis;
a light emitting device provided at a longitudinal end of the optical engine to provide light;
a reflector provided on a portion of the optical engine to reflect light;
an optical propagation part that extends from the optical engine in a direction away from the reflector, the optical propagation part to provide light to outside of the backlight unit; and
first light dispersion members provided between the reflector and the optical engine to disperse light within the optical engine, the first light dispersion members extending in a direction that is parallel to the longitudinal axis of the optical engine.

16. The backlight unit according to claim 15, further comprising second light dispersion members provided on the optical engine, the second light dispersion members extending in a direction that is transverse to the first light dispersion members.

17. The backlight unit according to claim 15, wherein the first light dispersion members are grooves or protrusions on the optical engine to disperse the light within the optical engine.

18. The backlight unit according to claim 15, wherein the first light dispersion members are provided in a regular pattern shape or a random pattern shape.

19. The backlight unit according to claim 15, wherein the longitudinal end of the optical engine is inclined.

20. The backlight unit according to claim 15, wherein the light emitting device is provided in an inclined manner at the longitudinal end of the optical engine.

21. A display device comprising:
the backlight unit of claim 11; and
a liquid crystal panel to receive light from the backlight unit.
